(19) United States
(12) Patent Application Publication
(10) Pub. No.: US 2015/0134765 A1
(43) Pub. Date: May 14, 2015

(54) POINT-TO-POINT SHARED MEMORY PROTOCOL WITH FEATURE NEGOTIATION

(71) Applicant: Qualcomm Innovation Center, Inc., San Diego, CA (US)

(72) Inventors: Eric S. Holmberg, Longmont, CO (US); Paul G. Adelsbach, Boulder, CO (US)

(73) Assignee: Qualcomm Innovation Center, Inc., San Diego, CA (US)

(21) Appl. No.: 14/077,036

(22) Filed: Nov. 11, 2013

(51) Int. Cl. G06F 15/173

(52) U.S. Cl. CPC G06F 15/17331; G06F 15/17337
USPC 709/212

(57) ABSTRACT

A method for negotiating a feature on a multiprocessor system includes determining, at a local processor, whether a remote shared memory (SMEM) item of a remote processor exists; reading, in response to determining that the remote SMEM item exists, a remote version and a remote feature flags value of the remote SMEM item; setting a local version number for a local SMEM item based on the remote version number; setting a local feature flags value for the local SMEM item based on the remote feature flags value; and creating the local SMEM item, the local SMEM item populated with the set local version number and the set local feature flags value.

### BACKGROUND

1. Field

The disclosure relates to the field of systems and methods for shared memory protocols in a multi-processor computer system, and, in particular, to systems and methods for shared memory point-to-point (P2P or SMP2P) protocols that allow for feature negotiation across subsystems.

2. Background

Multiprocessing computer systems include two or more processors (subsystems) that may be employed to perform computing tasks. Portions of a particular computing task may be distributed among multiple processors to decrease the time required to perform the computing task as a whole. A popular architecture in commercial multiprocessing computer systems is a shared memory architecture in which multiple processors share a common memory. According to some shared memory multiprocessor systems, data contents are “broadcast” from one processor to many (or all) other processors, as opposed to the shared memory point-to-point protocol that connects two processors directly, which allows for isolating the data contents to these processors only.

In addition, some shared memory multiprocessor systems encounter issues with incompatibility due to subsystem software releases. In particular, a new feature added to one subsystem may fail if software on a remote subsystem does not include the feature.

### SUMMARY

A method for negotiating a feature on a multiprocessor system includes (but is not limited to any one or combination of): determining, at a local processor, whether a remote shared memory (SMEM) item of a remote processor exists; reading, in response to determining that the remote SMEM item exists, a remote version and a remote feature flags value of the remote SMEM item; setting a local version number for a local SMEM item based on the remote version number; setting a local feature flags value for the local SMEM item based on the remote feature flags value; and creating the local SMEM item, the local SMEM item populated with the set local version number and the set local feature flags value.

In various embodiments, the local version number is set based on the lower of the remote version number and a highest local version number supported by the local processor.

In various embodiments, the local feature flags value is set based on the AND of the remote feature flags value and feature flags value of features supported by the local processor.

In various embodiments, in response to determining that the remote SMEM item does not exist, the method further includes creating the local SMEM item, the local SMEM item populated with a highest local version number supported by the local processor and a feature flags value of features supported by the local processor.

In various embodiments, the method further includes determining whether the local version number and the local feature flags value of the local SMEM item matches the remote version number and the remote feature flags value of the remote SMEM item.

In some embodiments, negotiation is complete if the local version number and the local features flags value of the local SMEM item matches the remote version number and the remote feature flags value of the remote SMEM item.

In some embodiments, in response to determining that the local version number and the local feature flags value of the local SMEM item does not match the remote version number and the remote feature flags value of the remote SMEM item, the method further includes determining whether the remote version number is less than the local version number.

In further embodiments, in response to determining the remote version number is less than the local version number, the method further includes setting the local version number based on the remote version number; and setting the local feature flags value based on the remote feature flags value.

In yet further embodiments, the local version number is set to the remote version number.

In yet further embodiments, the local feature flags value is set to the AND of the local feature flags value and the remote feature flags value.

In further embodiments, in response to determining the remote version number is not less than the local version number, the method further includes waiting for the remote processor to negotiate down the remote version number to match the local version number.

In various embodiments, the local SMEM item comprises a header.

In some embodiments, the local version number and the local feature flags value are provided in the header.

In some embodiments, an identifier for the local processor and an identifier for the remote processor are provided in the header.

In some embodiments, the local SMEM item comprises at least one data entry.

In some embodiments, the header includes a total number of entries value corresponding to a total number of data entries in the local SMEM item.

An apparatus for negotiating a feature on a multiprocessor system includes, but is not limited to, means for determining, at a local processor, whether a remote shared memory (SMEM) item of a remote processor exists; means for reading, in response to determining that the remote SMEM item exists, a remote version and a remote feature flags value of the remote SMEM item; means for setting a local version number for a local SMEM item based on the remote version number; means for setting a local feature flags value for the local SMEM item based on the remote feature flags value; and means for creating the local SMEM item, the local SMEM item populated with the set local version number and the set local feature flags value.

A computer program product for negotiating a feature on a multiprocessor system includes a computer-readable storage medium comprising code for (but not limited to): determining, at a local processor, whether a remote shared memory (SMEM) item of a remote processor exists; reading, in response to determining that the remote SMEM item exists, a remote version and a remote feature flags value of the remote SMEM item; setting a local version number for a local SMEM item based on the remote version number; setting a local feature flags value for the local SMEM item based on the remote feature flags value; and creating the local SMEM item, the local SMEM item populated with the set local version number and the set local feature flags value.

A method of negotiating a feature on a local processor of a multiprocessor system includes (but is not limited to any one or combination of): creating a local memory item at the local processor, the local memory item including a version number of the local processor and at least one feature flag of the local processor; determining a version number and flag of a remote memory item; comparing the version number and the feature flag of the local memory item with the version number and the feature flag of the remote memory item; and adjusting at least one of the version number and the feature flag of one or more of the local memory item and the remote memory item based on the comparison.

A method of processing data on a multiprocessor system having a plurality of processors including at least a first processor and a second processor, includes (but is not limited to any one or combination of): generating, with the first processor, a first memory item for the second processor; and generating, with the second processor, a second memory item for the first processor. Each of the memory items comprises a header and at least one data entry.

In various embodiments, the method further includes negotiating a feature of the first processor with a feature of the second processor based on the headers of the first memory item and the second memory item.

In various embodiments, the header of the first memory comprises a first version number and a first feature flags value; and wherein the header of the second memory item comprises a second version number and a second feature flags value.

In various embodiments, an identifier for the first processor and an identifier for the second processor are provided in the header of each of the memory items.

In various embodiments, the header of each of the memory items includes a total number of entries value corresponding to a total number of data entries in the SMEM item.

In various embodiments, a size of the first memory item and a size of the second memory item are the same.

In various embodiments, a size at the first memory item is different from a size of the second memory item.

In various embodiments, the first memory item is generated based on the second memory item.

In various embodiments, the plurality of processes further includes a third processor. The method further includes: generating, with the first processor, a third memory item for the third processor; and generating, with the third processor, a fourth memory item for the first processor.

In some embodiments, the method further includes: generating, with the second processor, a fifth memory item for the third processor; and generating, with the third processor, a sixth memory item for the second processor.

### BRIEF DESCRIPTION OF THE DRAWINGS

FIG. 1 is a block diagram of a multiprocessor system according to various embodiments of the disclosure.

FIG. 2 is a shared memory item according to various embodiments of the disclosure.

FIG. 3 is a negotiation algorithm according to various embodiments of the disclosure.

FIG. 4 is a negotiation algorithm according to various embodiments of the disclosure.

FIG. 5 is a negotiation algorithm according to various embodiments of the disclosure.

### DETAILED DESCRIPTION

Various embodiments are directed to an interrupt driven communication protocol across shared memory between two or more subsystems. The shared memory protocol is a point-to-point protocol (to increase security) that allows for feature negotiation across subsystems.

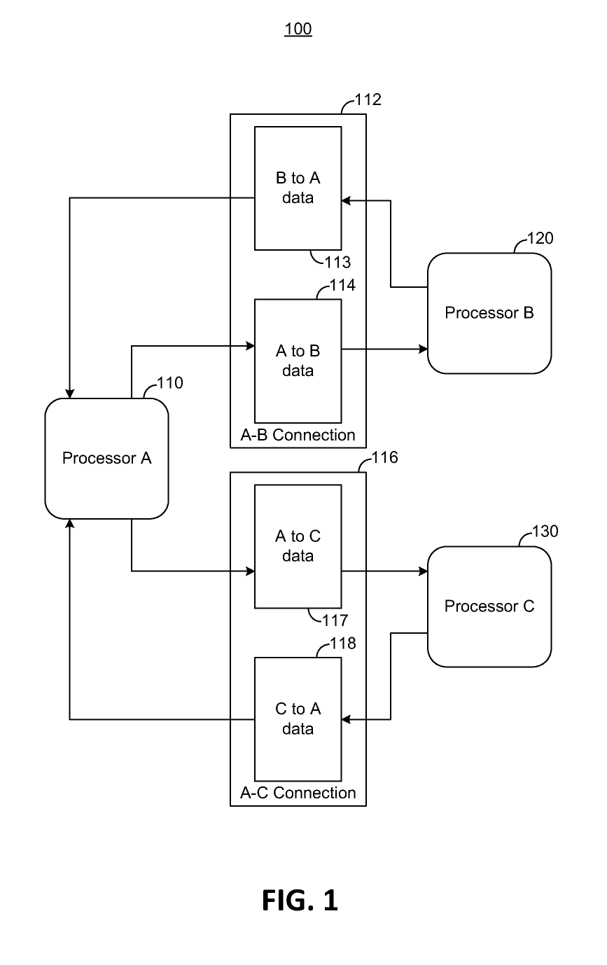

A shared memory multiprocessor system 100 having a plurality of processors (or endpoints), such as Processors A (110), B (120), and C (130), is shown in FIG. 1. Each processor has a connection or data path between another. For instance, the Processor A 110 and the Processor B 120 has a connection 112 and the Processor A 110 and the Processor C 130 has a connection 116. Although not shown, the Processor B 120 and the Processor C 130 has a connection.

Each connection (or data path) comprises two shared memory (SMEM) items (a first SMEM item and a second SMEM item) for each pair of connected processors. Each SMEM item contains outgoing SMP2P (shared memory peer-to-peer) traffic from a processor (also referred to as a local processor) to another processor (also referred to as a remote processor) of the plurality of processors. For instance, the connection 112 between the Processor A 110 and the Processor B 120 includes a “B to A data” SMEM item 113 and an “A to B data” SMEM item 114. The connection 116 between the Processor A 110 and the Processor C 130 includes an “A to C data” SMEM item 117 and a “C to A data” SMEM item 118. Although not shown, the connection between the Processor B 120 and the Processor C 130 includes a first SMEM item (e.g., C to B data SMEM item) and a second SMEM item (e.g., B to C data SMEM item).

Each local processor 110, 120, 130 is configured to generate its outbound SMEM item. For instance, the Processor A 110 generates the “A to B data” SMEM item 114, and the Processor B 120 generates the “B to A data” SMEM item 113. In some embodiments, one or more of the processors need not generate an SMEM item if there is no need for SMP2P traffic by the one or more processor. In some embodiments, if a remote processor begins SMP2P initialization, the local processor initializes and creates an SMEM item to complete a negotiation phase and enable the remote processor to send SMP2P traffic. According to various embodiments, a size of each SMEM item is determined by the local processor generating the SMEM item. In particular embodiments, a size of a first SMEM item, which is generated by a local processor need not match a size of a second SMEM item, which is generated by an opposing processor.

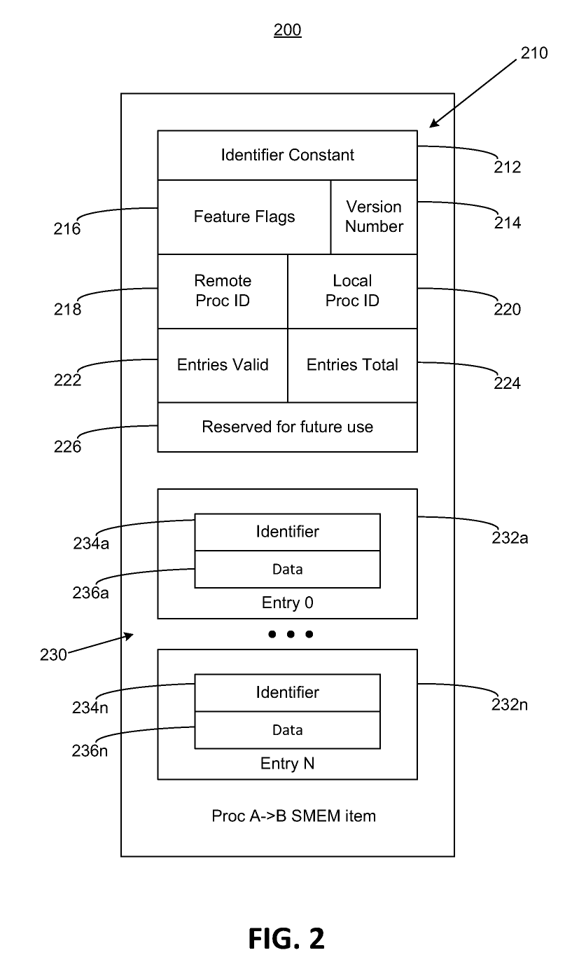

FIG. 2 illustrates a content layout of an SMEM item 200, which may correspond, for example, to the “A to B” data SMEM item 114 of FIG. 1. With reference to FIGS. 1 and 2, the SMEM item 200 includes a header 210 and at least one entry 230 (232a-232n). In some embodiments, one or more SMEM items includes a header 210 and zero entries 230.

The header 210 may include a plurality of fields, such as (but not limited to), an identifier constant 212, feature flags 216, version number 214, remote processor ID 218, local processor ID 220, entries valid 222, entries total 224, one or more reserved fields 226, and/or the like. In particular embodiments, fields with lower addresses are illustrated at the top of the SMEM item 200.

The identifier constant 212 may be a fixed value used to identify the structure in memory, may also be useful in debugging. The identifier constant 212 may be set to a valid value (e.g., 0×504D5324 (“$SMP”)). The identifier constant 212 may be any suitable size (e.g., 4 bytes).

The version number 214 indicates a set of mechanisms used by the current version of SMP2P software on a given connection. Negotiation of version number, for example as discussed in the disclosure, allows SMP2P software updates to be released in staggered fashion. The version number 214 may be set to a valid value. For example, the version number 214 may be set to 1 if there is only one version or the version number 214 may be set to any other value corresponding to the current version number. The version number 214 may be any suitable size (e.g., 1 byte).

The feature flags 216 are individual features that can be chosen prior to negotiation for a given connection. Negotiation of feature flags, for example as discussed in the disclosure, allows certain SMP2P features to be determined per connection. Feature flags may be specific to one or more version numbers. Endpoints may request any flags during negotiation by setting feature flags bits. During negotiation, if a requested feature flag bit is supported, the requested feature flag bit is accepted by the local endpoint. The feature flags 216 may be set to a valid value. For example, the feature flags 216 may be set to 0 if there are no features, or the feature flags 216 may be set to any other value corresponding to the appropriate features. The feature flag 216 may be any suitable size (e.g., 3 bytes).

The remote processor ID 218 is a processor ID of the endpoint that is receiving SMP2P traffic. The remote processor ID 218 may be set to a value corresponding to a particular processor type. For example, if the remote processor is an application processor, then the remote processor ID 218 may have a value of “0”; if the remote processor is a modem processor, then the remote processor ID 218 may have a value of “1”; if the remote processor is an audio processor, then the remote processor ID 218 may have a value of “2”; if the remote processor is a wireless, then the remote processor ID 218 may have a value of “4”; if the remote processor is a power processor, then the remote processor ID 218 may have a value of “6”; and so on. It should be noted that these processors and ID values are merely exemplary. These processors may have other ID values and/or other processors may be included. The remote processor ID 218 may be any suitable size (e.g., 2 bytes).

The local processor ID 220 is a processor ID of the endpoint that is initiating outbound SMP2P traffic. The local processor ID 220 may be set to a value corresponding to a particular processor type, for example as described with respect to the remote processor ID 218. The local processor ID 220 may be any suitable size (e.g., 2 bytes).

The entries total 224 is a total number of entries in the SMEM item 200. The entries total 224 may be set to a value of zero or greater. The entries total 224 may be any suitable size (e.g., 2 bytes).

The entries valid 222 is a number of valid entries in the SMEM item 200. The entries valid 222 may be set to a value between zero and the value of entries total 224. The entries valid 222 may be any suitable size (e.g., 2 bytes).

The reserved field 226 may be reserved for future use. The reserved field 226 may be set to a valid value, such as 0. The reserved field 226 may be any suitable size (e.g., 4 bytes).

In various embodiments, zero or more entries 230 may follow the header 210. In particular embodiments, the number of entries 230 in the SMEM item 200 is determined by the size of the SMEM item 200. After the header 210, remaining bytes in the SMEM item 200 may be dedicated to the entries 230.

Each entry 230 may include a plurality of fields, such as (but not limited to), an identifier string (e.g., 234a) and a data field (e.g., 236a). The identifier string 234a may be, for example, an ASCII string (e.g., null-terminated ASCII string) or the like. The identifier string may have a valid value (e.g., non-null for valid entries). The identifier string 234a may be any suitable size (e.g., 16 bytes). The data field 236a may data content between processors and may have any suitable values. The data field 236a may be any suitable size (e.g., 4 bytes).

SMEM Item Identifiers are defined, for example, according to the following table, based on the processor IDs 218, 220 defined previously.

| Description | SMEM ID value |
|---|---|
| Apps SMP2P SMEM Item | 427 |
| base | |
| Apps to Modem | 428 (base + Modem Processor ID) |
| Apps to Audio | 429 (base + Audio Processor ID) |
| Apps to Wireless | 431 (base + Wireless Processor ID) |
| Apps to Power | 433 (base + Power Processor ID) |
| Modem SMP2P SMEM item | 435 |
| base | |
| Modem to Apps | 435 |
| Modem to Audio | 437 |
| Modem to Wireless | 439 |
| Modem to Power | 441 |
| Audio SMP2P SMEM Item | 443 |
| base | |
| Wireless SMP2P SMEM Item | 451 |
| base | |
| Power SMP2P SMEM Item | 459 |
| base | |

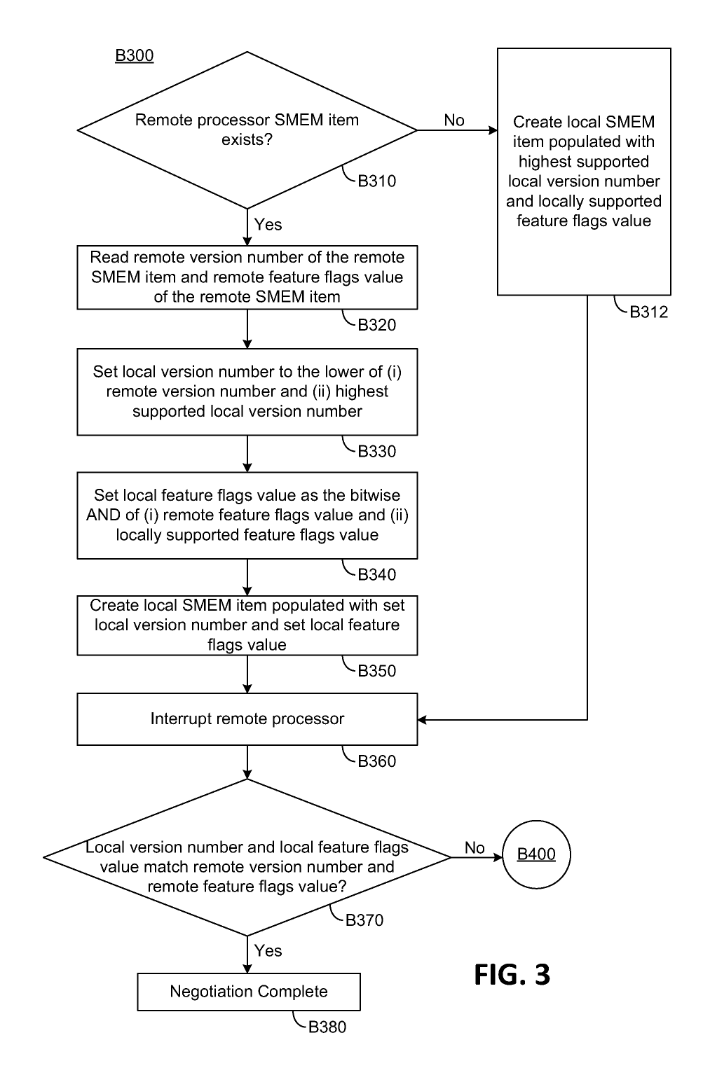

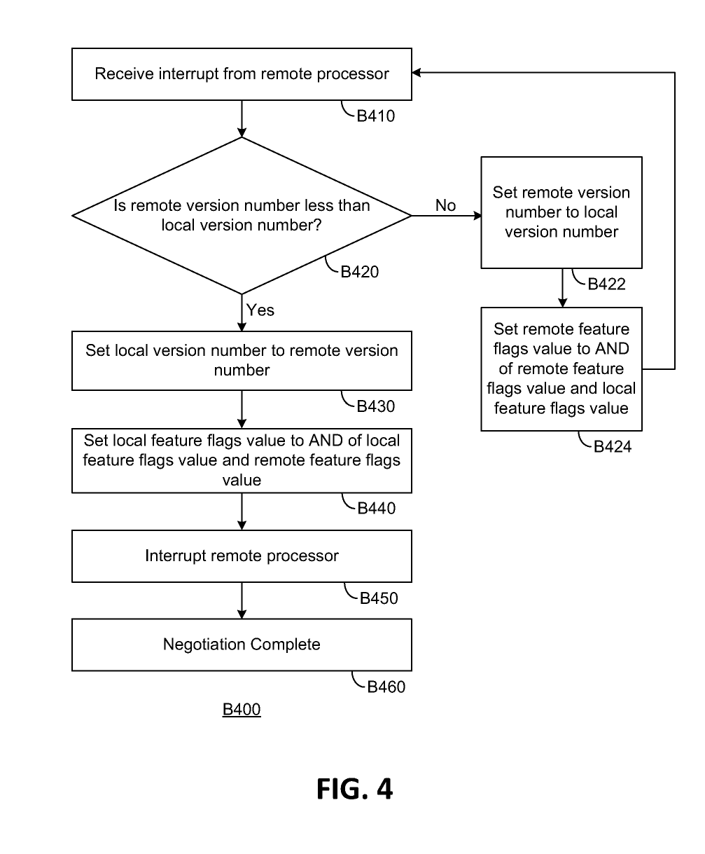

FIGS. 3 and 4 illustrate flowcharts of a negotiation algorithm B300, B400 that occurs when establishing a connection at a local endpoint (corresponding, for example, to the local processor ID 220 in FIG. 2) to a remote endpoint (corresponding, for example, to the remote processor ID 218 in FIG. 2).

With reference to FIGS. 1-4, at block B310, a determination is made, by the local processor 220, whether the remote processor 218 SMEM item exists. If the remote processor 218 SMEM item exists (B310: Yes), then, at block B320, the remote version number and remote flags value of the remote SMEM item is read.

At block B330, the local version number for the local SMEM item is set to the lower of (i) the remote version number and (ii) highest supported local version number. At block B340, the flags value for the local SMEM item is set, for example, as the bitwise AND of (i) the remote flags value and (ii) locally supported flags value.

At block B350, the local SMEM item is created at the local processor 220. The local SMEM item is populated with the set local version number (B330) and the set flags value (B340). The algorithm B300 then proceeds to block B360 where the remote processor 218 is interrupted.

If the remote processor 218 SMEM item does not exist (B310: No), then, at block B312, the local SMEM item is created at the local processor 220. The local SMEM item is populated with the highest supported local version number and locally supported flags value. The algorithm B300 then proceeds to block B360 where the remote processor 218 is interrupted.

After the remote processor 218 is interrupted at block B360, at block B370, a determination is made at the remote processor 218 as to whether the local version number and the local flags value match the remote version number and the remote flags value. If the local version number and the local flags value match the remote version number and the remote flags value (B370: Yes), then negotiation is complete (block B380).

If the local version number and the local flags value do not match the remote version number and the remote flags value (B370: No), then the local processor 220 waits to receive interrupt from the remote processor 218.

Upon receiving the interrupt from the remote processor 218 (block B410), at block B420, the local processor 220 determines whether the remote version number is less than the local version number. If the remote version number is less than the local version number (B420: Yes), then at block B430, the local version is set to the remote version number. At block B440, the local flags value is set as the AND of the local flags value and the remote flags value. At block B450, the remote processor 218 is interrupted, and negotiation is completed (block B460).

If the remote version number is not less than the local version number (B420: No), then at block B422, the remote version number is set to the local version number. At block B424, the remote flags value is set to the AND of the remote flags value and the local flags value. Following this, the local processor 220 waits to receive an interrupt from the remote processor 218 (block B410).

According to various embodiments, to creating an entry (e.g., 232n), new entries are created at the end of the entry array in the SMEM item 200. The sequence may be as follows. First, entries valid 222 and entries total 224 are compared to determine if there is room in the entry array for this connection. If no entries available, then no entry is created. Otherwise, the identifier 234n of the new entry 232n is populated. Accordingly, the entries valid field 222 may be incremented, and the remote endpoint is interrupted.

According to various embodiments, a sequence to write data to an entry (e.g., 232a) includes updating the data field (e.g., 236a) of the entry, and then interrupting the remote endpoint.

According to various embodiments, an SMP2P interrupt may be received when the remote endpoint is opening a connection or is in negotiation. This may occur when the connection between local processor and interrupt source is not open. An SMP2P interrupt may be received when the remote endpoint has created a new entry. This may occur when the connection is open and the entries valid 222 has changed since the last interrupt. An SMP2P interrupt may be received when the remote endpoint has written data. This may occur when the connection is open and data has been written to an entry.

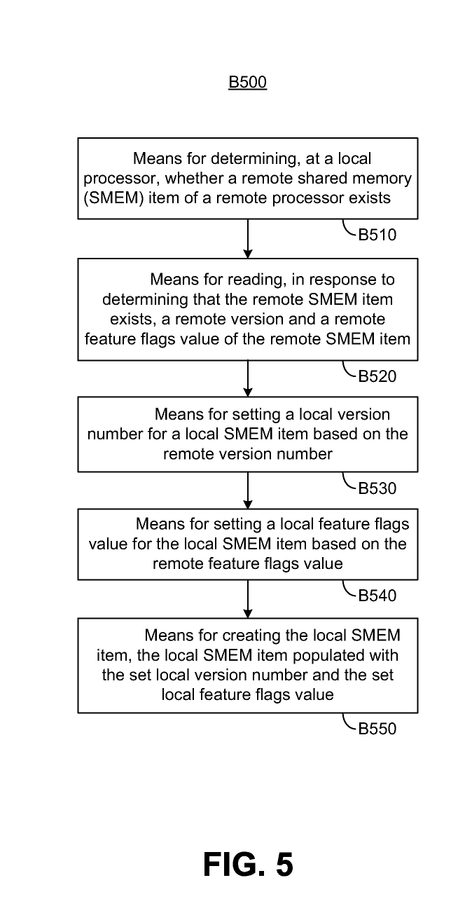

The algorithms(s) B300 and/or B400 described in FIGS. 3 and 4 above may be performed by various hardware and/or software component(s) and/or module(s) corresponding to the means-plus-function blocks B500 illustrated in FIG. 5. For instance, blocks B310 through B350 illustrated in FIG. 3 may correspond to means-plus-function blocks B510 through B550 illustrated in FIG. 5.

It is understood that the specific order or hierarchy of steps in the processes disclosed is an example of illustrative approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the implementations disclosed herein may be implemented as electronic hardware, computer software embodied on a tangible medium, or combinations of both. To clearly illustrate this interchangeability of hardware and software, various illustrative components, blocks, modules, circuits, and steps have been described above generally in terms of their functionality. Whether such functionality is implemented as hardware or software embodied on a tangible medium depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the implementations disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the implementations disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An illustrative storage medium is coupled to the processor such the processor can read information from, and write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal.

In one or more illustrative implementations, the functions described may be implemented in hardware, software or firmware embodied on a tangible medium, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and Blu-Ray disc where disks usually reproduce data magnetically, while discs reproduce data optically with lasers. Combinations of the above should also be included within the scope of computer-readable media.

The previous description of the disclosed implementations is provided to enable any person skilled in the art to make or use the present disclosure. Various modifications to these implementations will be readily apparent to those skilled in the art, and the generic principles defined herein may be applied to other implementations without departing from the spirit or scope of the disclosure. Thus, the present disclosure is not intended to be limited to the implementations shown herein but is to be accorded the widest scope consistent with the principles and novel features disclosed herein.

What is claimed is:

1. A method for negotiating a feature on a multiprocessor system, the method comprising:
determining, at a local processor, whether a remote shared memory (SMEM) item of a remote processor exists;
reading, in response to determining that the remote SMEM item exists, a remote version and a remote feature flags value of the remote SMEM item;
setting a local version number for a local SMEM item based on the remote version number;
setting a local feature flags value for the local SMEM item based on the remote feature flags value; and
creating the local SMEM item, the local SMEM item populated with the set local version number and the set local feature flags value.

2. The method of claim 1, wherein the local version number is set based on the lower of the remote version number and a highest local version number supported by the local processor.

3. The method of claim 1, wherein the local feature flags value is set based on the AND of the remote feature flags value and feature flags value of features supported by the local processor.

4. The method of claim 1, wherein, in response to determining that the remote SMEM item does not exist, the method further comprising:
creating the local SMEM item, the local SMEM item populated with a highest local version number supported by the local processor and a feature flags value of features supported by the local processor.

5. The method of claim 1, the method further comprising:
determining whether the local version number and the local feature flags value of the local SMEM item matches the remote version number and the remote feature flags value of the remote SMEM item.

6. The method of claim 5, wherein negotiation is complete if the local version number and the local features flags value of the local SMEM item matches the remote version number and the remote feature flags value of the remote SMEM item.

7. The method of claim 5, wherein, in response to determining that the local version number and the local feature flags value of the local SMEM item does not match the remote version number and the remote feature flags value of the remote SMEM item, the method further comprising:
determining whether the remote version number is less than the local version number.

8. The method of claim 7, wherein, in response to determining the remote version number is less than the local version number, the method further comprising:
setting the local version number based on the remote version number; and
setting the local feature flags value based on the remote feature flags value.

9. The method of claim 8, wherein the local version number is set to the remote version number.

10. The method of claim 8, wherein the local feature flags value is set to the AND of the local feature flags value and the remote feature flags value.

11. The method of claim 7, wherein, in response to determining the remote version number is not less than the local version number, the method further comprising:
waiting for the remote processor to negotiate down the remote version number to match the local version number.

12. The method of claim 1, wherein the local SMEM item comprises a header.

13. The method of claim 12, wherein the local version number and the local feature flags value are provided in the header.

14. The method of claim 12, wherein an identifier for the local processor and an identifier for the remote processor are provided in the header.

15. The method of claim 12, wherein the local SMEM item comprises at least one data entry.

16. The method of claim 15, wherein the header includes a total number of entries value corresponding to a total number of data entries in the local SMEM item.

17. An apparatus for negotiating a feature on a multiprocessor system, the apparatus comprising:
means for determining, at a local processor, whether a remote shared memory (SMEM) item of a remote processor exists;
means for reading, in response to determining that the remote SMEM item exists, a remote version and a remote feature flags value of the remote SMEM item;
means for setting a local version number for a local SMEM item based on the remote version number;
means for setting a local feature flags value for the local SMEM item based on the remote feature flags value; and
means for creating the local SMEM item, the local SMEM item populated with the set local version number and the set local feature flags value.

18. A non-transitory, tangible processor readable storage medium, encoded with processor readable instructions to perform a method for negotiating a feature on a multiprocessor system, the method comprising:
determining, at a local processor, whether a remote shared memory (SMEM) item of a remote processor exists;
reading, in response to determining that the remote SMEM item exists, a remote version and a remote feature flags value of the remote SMEM item;
setting a local version number for a local SMEM item based on the remote version number;
setting a local feature flags value for the local SMEM item based on the remote feature flags value; and
creating the local SMEM item, the local SMEM item populated with the set local version number and the set local feature flags value.
